(19) United States
(12) Patent Application Publication
(10) Pub. No.: US 2012/0094713 A1
(43) Pub. Date: Apr. 19, 2012

(54) Mobile phone including a streaming server providing a method of copying a distance of the image on the screen

(75) Inventor: Olivier Yves Marc Renou, Chambery (FR)

(73) Assignee: MYRIAD GROUP AG, Zurich (CH)

(21) Appl. No.: 13/136,282

(22) Filed: Jul. 28, 2011

(30) Foreign Application Priority Data
Jul. 29, 2010 (FR) FR 10 56255

(51) Int. Cl. H04W 88/02

(52) U.S. Cl. 455/556.1

(57) ABSTRACT

The mobile phone (12) includes a display screen (24), a display generator (26) for displaying an image on the screen, a capturer (28) for capturing an image displayed on the screen, the capturer (28) being adapted to capture the image passing between the display means (26) and the screen (24), and a streaming server (18) for streaming data to a remote client equipment (14) according to a predetermined network protocol.

The streaming server (18) is adapted to be connected to the remote client equipment (14) via a data link (16) and is adapted to receive, from the remote client equipment (14), a data streaming request.

The streaming server (18) includes an activator (44) for activating the capturer (28), the streaming server (18) being adapted to transmit the captured image to the remote client equipment (14).

This claims the benefit of French Patent Application FR 10 562 55, filed Jul. 29, 2010 and hereby incorporated by reference herein.

The present invention relates to a mobile phone of the type comprising:

a. a display screen,
b. a display means for displaying an image on the screen,
c. a capture means for capturing an image displayed on the screen, the capture means being adapted to capture the image passing between the display means and the screen,
d. a streaming server for streaming data to a remote client equipment according to a predetermined network protocol, the streaming server being adapted to be connected to the remote client equipment via a data link and to receive, from the remote client equipment, a data streaming request.

The invention also relates to a local data communication network including such a mobile phone and remote client equipment connected to the mobile phone via a data link, the mobile phone and the remote client equipment being adapted to communicate using a predetermined network protocol.

A mobile phone of the aforementioned type is known. The streaming server is generally compatible with the UPnP (Universal Plug and Play) network protocol, or respectively with the DLNA (Digital Living Network Alliance) interoperability standard, the server then being called a UPnP server or DLNA server, respectively. Such a server makes it possible to stream media, recorded in an internal memory of the phone, to a remote client equipment also compatible with the UPnP network protocol, or with the DLNA standard. The streamed media includes audio and/or video data.

However, the streaming server, installed on a mobile phone and operating in particular under an Android-type operating system, offers a limited number of functionalities. The server essentially makes it possible to stream audio and/or video media, recorded in the internal memory of the phone, to the client equipment.

### SUMMARY OF THE INVENTION

It is an object of the present invention to provide a mobile phone comprising a streaming server and offering an additional functionality.

The present invention provides a mobile phone of the aforementioned type, wherein the streaming server includes an activation means for activating the capture means, the streaming server being adapted to send the captured image to the remote client equipment.

According to other embodiments, the mobile phone comprises one or more of the following features, considered alone or according to all technically possible combinations:

a. the activation means is adapted to activate the capture means periodically according to a first period;
b. each captured image is according to a first format, the remote client equipment being compatible with a second format distinct from the first format, and the mobile phone also includes a buffer memory connected to the capture means and adapted to store the captured image, a conversion means for converting each captured image from the first format to the second format, the conversion means being connected in output to the buffer memory, and the streaming server being adapted to transmit the converted image to the remote client equipment;
c. the streaming server has a control means for controlling the conversion means, the control means being adapted to command the conversion of each captured image from the first format to the second format.

The invention also relates to a local data communication network of the aforementioned type, wherein the mobile phone is as defined above.

According to other embodiments, the local network comprises one or more of the following features, considered alone or according to all technically possible combinations:

a. the remote client equipment includes a display means for displaying, periodically according to a second period, each image received from the streaming server, and the first period is greater than or equal to the second period;
b. the mobile phone also includes a buffer memory connected between the capture means and the streaming server, and a duplication means for duplicating the captured image in the buffer memory, the streaming server being adapted to communicate to the remote client equipment the images captured and duplicated, the number of duplicated images from each captured image depending on the ratio between the first period and the second period.

The invention also relates to a method implemented by a mobile phone comprising a display screen, a display means for displaying an image on the screen, a capture means for capturing an image displayed on the screen, and a streaming server connected to the capture means, the streaming server being adapted to be connected to the remote client equipment via a data link and to receive, from the remote client equipment, a data streaming request,

the method comprising:

a. the selection by the user of a remote copy mode of an image displayed on the screen of the mobile phone,
b. the transmission, by the streaming server, of an activation signal for the capture means,
c. the capture, by the capture means, of the image passing between the display means and the screen, upon receipt of said activation signal, and
d. the transmission of the captured image to the remote client equipment, by the streaming server and according to a predetermined network protocol.

According to other embodiments, the method comprises one or more of the following features, considered alone or according to all technically possible combinations:

a. a video file including a plurality of images is transmitted during the transmission step;
b. the method also comprises a step for correcting the capture date of the next captured image as a function of the transmission date of the preceding captured image.

The invention also relates to a computer program product including instructions that, when they are implemented by a computer incorporated into a mobile phone, implements the method as defined above.

### BRIEF DESCRIPTION OF THE DRAWINGS

These features and advantages of the invention will appear upon reading the following description, provided solely as an example, and done in reference to the appended drawings, in which:

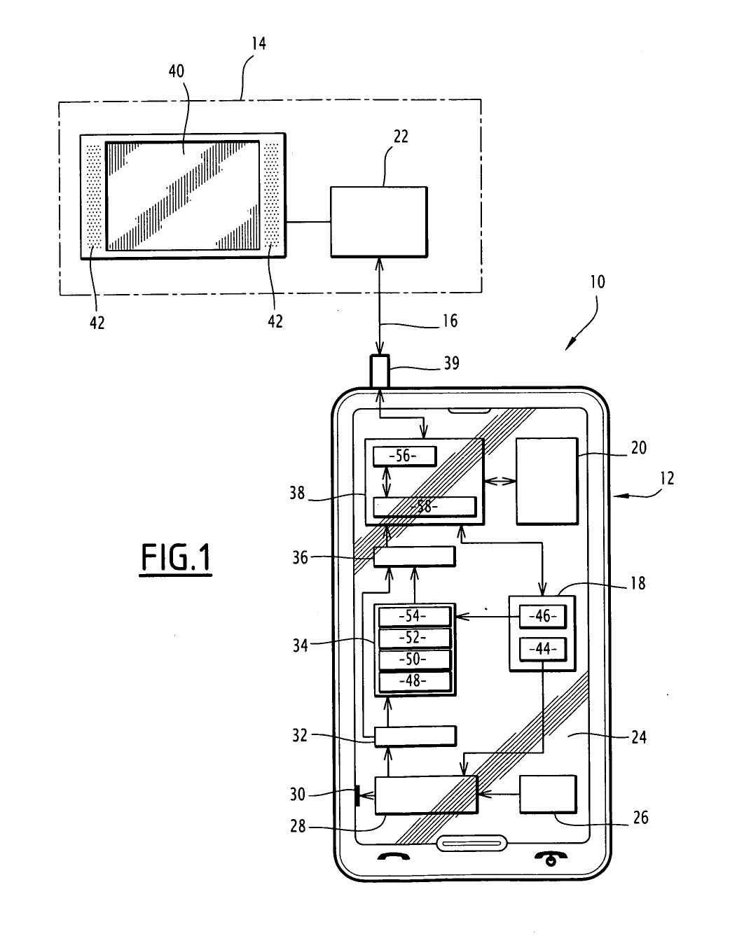

a. FIG. 1 is a diagrammatic illustration of a local data communication network including a mobile phone according to the invention,

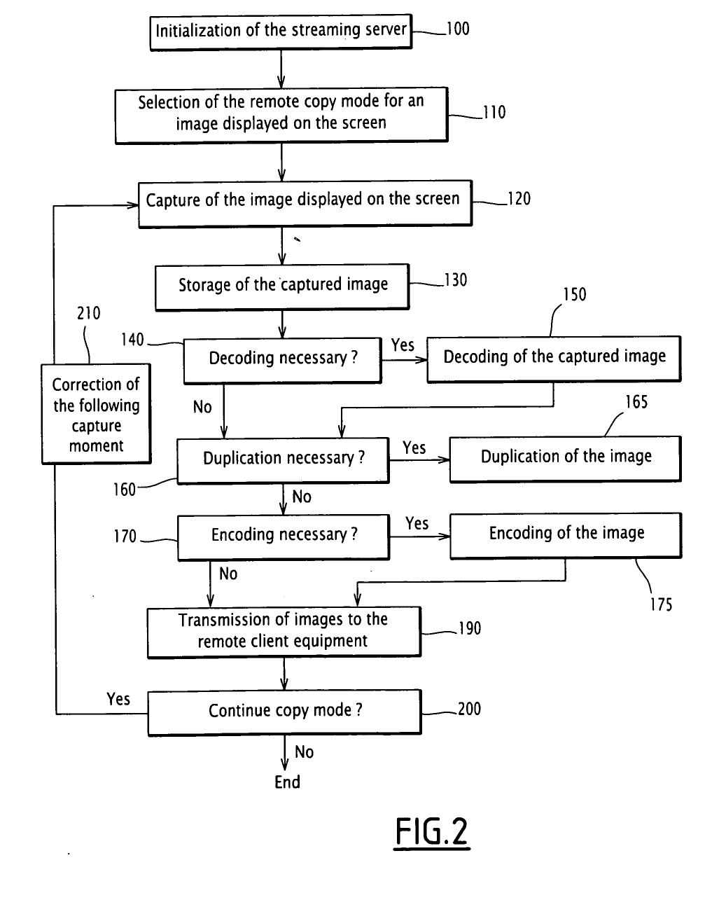

b. FIG. 2 is a flowchart of a method implemented by the mobile phone of FIG. 1,

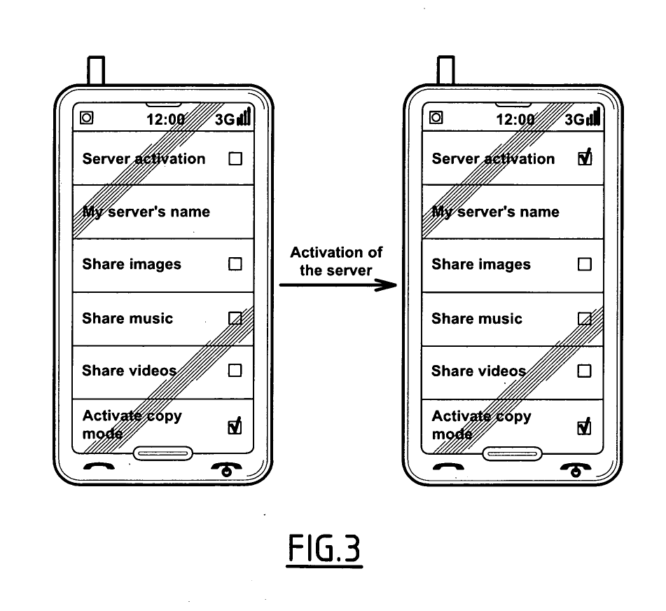

c. FIG. 3 is a diagrammatic illustration of the man-machine interface of the mobile phone during two successive phases of a step for initializing a server of the mobile phone,

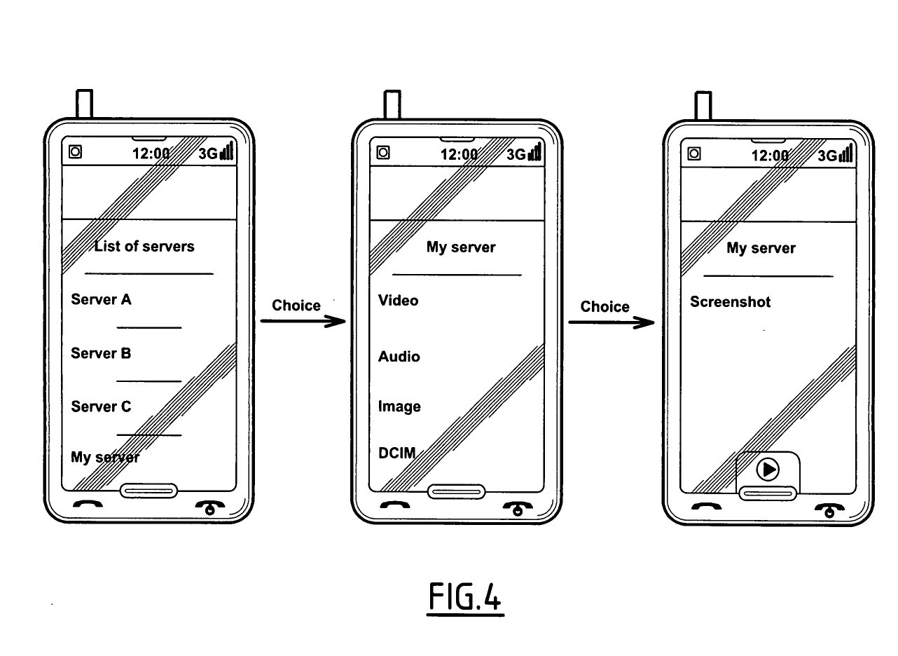

d. FIG. 4 is a diagrammatic illustration of the man-machine interface of the mobile phone during successive phases of a step for selecting a remote copy mode for copying an image displayed on the screen of the phone, and

e. FIG. 5 diagrammatically shows the processing of different images captured at successive moments and the creation of a video media for streaming thereof by the server.

### DETAILED DESCRIPTION

The invention is in particular applicable to a mobile phone using the Android® operating system by Google. Alternatively, the invention applies to a mobile phone operating under any operating system of the same type as the Android® operating system.

In FIG. 1, a local data communication network 10 comprises a mobile phone 12 and remote client equipment 14 connected to the mobile phone via a radio link 16. The mobile phone 12 and the remote client equipment 14 are adapted to communicate according to a predetermined network protocol.

The predetermined network protocol is in compliance with standard ISO/IEC 29341, and is also called UPnP network protocol (Universal Plug and Play).

Complementarily, the predetermined network protocol is also in compliance with the DLNA (Digital Living Network Alliance) interoperability standard.

According to the UPnP standard or the DLNA standard, the local communication network 10 includes a streaming server 18, also called media server, a remote control device 20, and a client device 22, also called renderer.

When the predetermined network protocol is the UPnP protocol, the streaming server 18, the control device 20 and the renderer 22 are respectively called UPnP server, UPnP controller and UPnP client.

When the predetermined network protocol is also in compliance with the DLNA standard, the streaming server 18, the control device 20 and the client device 22 are respectively called DLNA server, DLNA controller and DLNA client.

In the embodiment of FIG. 1, the mobile phone 12, shown in the form of functional modules, includes the streaming server 18 and the control device 20. The remote client equipment 14 includes the client device 22.

Alternatively, the mobile phone includes the streaming server, but does not include the control device, an independent electronic apparatus comprising said control device. The remote client equipment includes the client device.

Alternatively, the mobile phone includes the streaming server, but does not include the control device, the remote client equipment comprising both the control device and the client device.

The mobile phone 12 comprises a display screen 24, a display means or generator 26 for displaying an image on the screen, a capture means or capturer 28 for capturing an image displayed on the screen, and a video input bus 30 for the screen.

According to one embodiment, the mobile phone 12 includes a first buffer memory 32 connected as output of the capture means 28, a conversion means or converter 34 for converting data connected in the output of the first buffer memory, and a second buffer memory 36 connected at the output of the capture means, the conversion means.

The mobile phone 12 also includes a radio transmitter-receiver 38 and a radio antenna 39.

The mobile phone 12 includes an information processing unit formed, for example, by a data processor associated with a memory. The processing unit is also called a computer. The memory includes the first and second buffer memories 32, 36 and is adapted to store different software. The streaming server 18, the control device or controller 20, the display means 26, the capture means 28 and the conversion means 34 respectively include streaming server software, control software, software for displaying an image on the screen, software for capturing an image displayed on the screen, and data conversion software.

The remote client equipment 14 includes the client device 22, as well as a video data display screen 40 from the client device 22 and the audio data reproduction speakers 42 from the client device.

The radio link 16 is in compliance with standard IEEE 802.11, also called Wi-Fi™ standard, or standard IEEE 802.15, also called Bluetooth® standard.

The streaming server 18 is connected to the client device 22 of the remote client equipment via the transmitter-receiver 38 and the radio link 16. The streaming server 18, the control device 20 and the client device 22 are adapted to communicate via a hypertext transfer protocol, such as the HTTP protocol (HyperText Transfer Protocol).

The streaming server 18 is adapted to receive, from the client device 22 of the client equipment, a data streaming request, and to transmit in response data to said client device 22 according to the predetermined network protocol.

The streaming server 18 according to the invention includes an activation means or activator 44 for activating the capture means, the streaming server 18 being adapted to transmit the captured image in the form of an image file to the remote client equipment 14 via the transmitter-receiver 38, when the capture image does not need to be converted before transmission. Alternatively, the streaming server 18 is adapted to transmit a video file to the remote client equipment 14, the video file including a plurality of captured images.

According to one embodiment, the streaming server 18 includes a control means 46 for controlling the conversion means.

The capture means 28 is adapted to capture the image passing between the display means 26 and the screen 24, the capture means 28 being connected between the display means 26 and the video input bus 30.

Each captured image is according to a first format, and the client device 22 of the remote client equipment is compatible with a second format.

The conversion means or converter 34 is adapted to convert each captured image from the first format to the second format, then to store the converted image in the second buffer memory 36. The streaming server 18 is adapted to transmit the converted image, in the form of the image file, to the client device 22 of the remote client equipment via the transmitter-receiver 38. Alternatively, the streaming server 18 is adapted to transmit the video file to the remote client equipment 14, the video file including a plurality of converted images.

The conversion means 34 comprises a video decompression means 48, also called a decoding means, adapted to decompress the captured image, when the first format of the captured image corresponds to compressed data.

The conversion means 34 comprises a resize means for resizing the captured and possibly decompressed image.

The conversion means 34 comprises a duplication means 50 adapted to duplicate a resized decompressed captured image. The duplication means 50 is connected to the capture means 28 on the one hand, and to the decompression means 48 on the other hand.

The conversion means 34 comprises an encoding means 52 adapted to encode a captured or duplicated image, possibly decompressed, when the video attributes of the second format are different from those of the first format. The encoding means 52 is connected to the capture means 28, the decompression means 48, and the duplication means 50.

The conversion means 34 comprises an encrypting means 54, adapted to encrypt the image captured or duplicated, possibly decompressed and/or encoded, when the second format corresponds to the encrypted data. The encrypting means 54 is connected to the capture means 28, the decompression means 48, the duplication means 50, and the encoding means 52.

The radio transmitter-receiver 38 includes a transmission-reception means 56 for transmitting and receiving radio signals and a transmission-reception buffer memory 58. The transmission-reception means 56 is connected to the radio antenna 39, and the transmission-reception buffer memory 58 is connected between the second buffer memory 36 and the transmission-reception means 56.

The activation means 44 is adapted to activate the capture means 28 periodically according to a first period ΔT1, and the client device 22 is adapted to display, periodically according to a second period ΔT2, each image received from the streaming server 18. The first period ΔT1 is, for example, greater than or equal to the second period ΔT2.

Alternatively, the activation means 44 is adapted to activate the capture means 28 aperiodically. Alternatively, the activation means 44 is adapted to activate the capture means 28 as a single unit.

The control means 46 is adapted to control the conversion of each captured image from a first format to a second format, when the second format is different from the first format.

More precisely, the control means 46 is adapted to control the decompression of each captured image, also called decoding of each captured image, when the first format of the captured image corresponds to compressed data.

The control means 46 is adapted to command the duplication of each captured or decompressed image, when the first period is strictly greater than the second period, with a view to the transmission by the streaming server 18 of an adapted number of images to the client device 22 of the remote client equipment. The number Nd of duplicated images from each captured or transcoded image depends on the ratio between the first period ΔT1 and the second period ΔT2.

The control means 46 is adapted to command the encoding of each captured or duplicated, possibly decompressed, image when the video attributes of the second format are different from those of the first format.

The control means 46 is adapted to command the encryption of each captured or duplicated, possibly decompressed and/or encoded, when the second format corresponds to encrypted data.

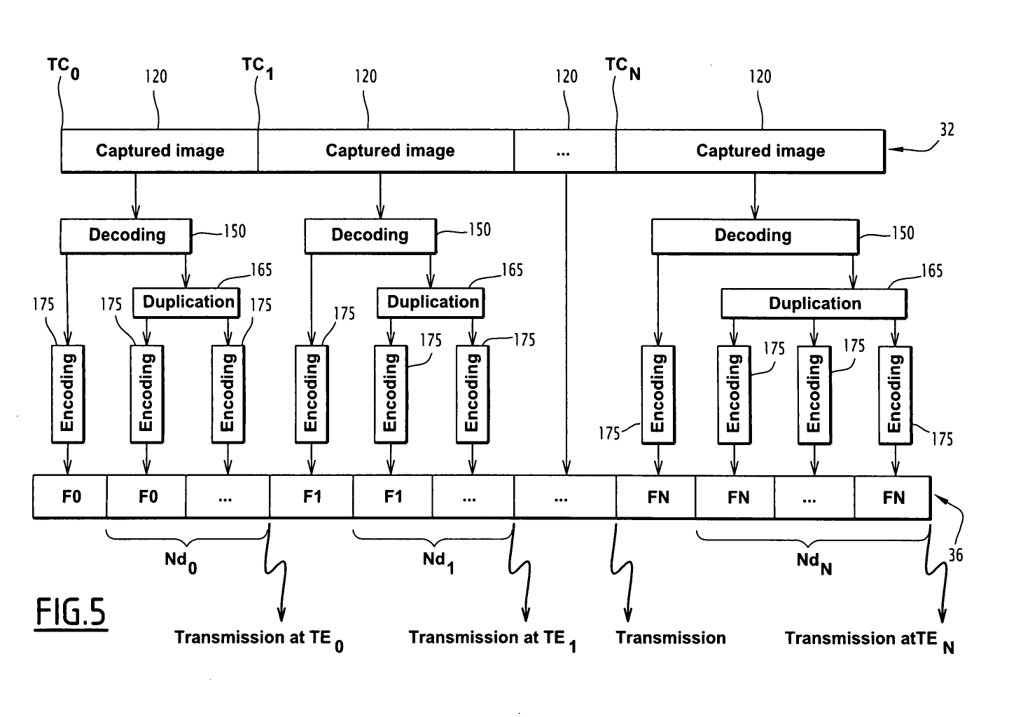

The operation of the local transmission network 10 according to the invention will be explained below using FIGS. 2 to 7.

FIG. 2 illustrates a method for remotely copying, on the display screen 40 of the remote client equipment, an image displayed on the screen 24 of the mobile phone.

During the initial step 100, the user starts by authorizing the operation of the phone 12 in a remote copy mode for remotely copying an image displayed on the screen of said phone by checking the box “Activate copy mode,” as shown in FIG. 3. The user then activates the streaming server 18 by checking the “Activate server” box.

At the end of this initial step, the streaming server 18 of the phone is ready to transmit, via its activation means 44, activation signals to the capture means 28, upon receipt by the remote client equipment 14 of a streaming request corresponding to the remote copy mode.

After activating the streaming server 18, the user consults, in step 110, via the control device 20, the list of available streaming servers, and chooses the server 18 previously activated, called “My server” in the embodiment of FIG. 4. When the user has selected the server 18 and initiated reading of the image or video file, the control device 20 sends a request to the server 18 so as to have a list of media directories adapted to be streamed, and the server responds by transmitting the list of directories. In the example of FIG. 4, the user then chooses the “Video” directory, which contains a video file called “Screenshot,” the list of video(s) contained in the “Video” directory being obtained by request from the control device 20 to the streaming server 18.

At that moment, the “Screenshot” video file is an empty file not containing any captured image. This video file is created upon authorization of the remote copy mode, previously described, to be adapted to be selected by the user when the latter navigates using the control device 20 in the list of media directories that are likely to be streamed.

By selecting the “Screenshot” video file, the user commands the beginning of remote copying of the images displayed on the screen of the phone. In fact, after having detected the selection of this “Screenshot” video file, the control device 20 sends a request to the streaming server 18 so as to obtain a web address, also known as a URL (Uniform Resource Locator), associated with said “Screenshot” video file.

In response, the streaming server 18 returns a list of URLs, the first URL corresponding to a default format, and the following URLs corresponding to formats of transcoded images. As a supplement to the list of URLs, the streaming server 18 also sends a list of proposed formats, each format being associated with a URL. The control device 20 also sends a request to the client device 22, in order to obtain the list of formats supported by the client device 22.

The control device 20 then compares the list of different formats proposed by the streaming server 18 with the list of formats supported by the client device 22, and selects a format common to these two lists. In other words, the common format selected is the second format previously described. The control device 20 then transmits to the client device 22 the URL resulting from the list sent by the streaming server 18 and corresponding to the selected common format.

The client device 22 sends the streaming server 18 a request containing the URL previously received from the control device 20. During step 120, the streaming server 18 then sends, upon receipt of said request from the client device 22 and via the activation means 44, an activation signal for the capture means 28 to capture the image passing between the display means 26 and the screen 24.

The capture means 28 records the captured image in the first buffer memory 32 during step 130.

The streaming server 18 then determines, in step 140, whether it is necessary to decode the captured image. In other words, the streaming server determines whether the first format of the captured image corresponds to compressed data.

When decoding is necessary, i.e. when the first format of the captured image corresponds to compressed data, the control means 46 sends control signals to the decoding means 48, and the decoding means 48 then decodes the captured image from the first format towards a non-compressed format.

At the end of the decoding step (step 150), or directly after step 140 if no decoding is necessary, the streaming server 18 determines, during step 160, whether a duplication of the captured or decoded image is necessary. In other words, the streaming server determines whether the first image capture period is greater than the second display period of the client device 22.

When the duplication is necessary, i.e. when the first period is greater than the second period, the control means 46 sends control signals to the duplication means 50, and the duplication means 50 then duplicates the captured or decoded image during step 165.

The duplicated image is copied Nd times, where Nd is the number of duplicated images from the captured or transcoded image. The number Nd depends on the ratio R between the first period and the second period.

When the ratio R between the first period and the second period is an integer greater than or equal to 2, knowing that the first period is greater than the second period in the case of a duplication, then the number Nd is equal to R−1.

When the ratio R between the first period and the second period is not an integer, then the number Nd varies from one captured image to the next. The number of images duplicated for the first captured image, denoted Nd0, is equal to the arithmetic rounding of R−1, and one then determines a corrective coefficient Coeff_Nd0 to calculate the next number of duplicated images Nd1, according to the following equations:

Nd0=Rounding(R)−1, (1)

Coeff_{—}Nd0=R−Nd0−1, (2)

Nd1=Rounding(R−Coeff_{—}Nd0)−1, (3)

where Rounding represents the rounding to the closest integer function, also called arithmetic rounding.

The subsequent numbers of duplicated images Ndj+1 are calculated iteratively using the following equations:

Coeff_{—}Ndj=R−Ndj−1, (4)

Ndj+1=Rounding(R−Coeff_{—}Ndj)−1, (5)

As an example, the client device 22 displays 25 images per second, and the capture means 28 captures an image displayed on the screen of the phone every 180 ms. The first period is equal to 180 ms and the second period is equal to 40 ms. The ratio R is equal to 4.5, and the number Nd is then, for example, equal to 4 for the even captured images and 3 for the odd captured images, where the first captured image is numbered as zero.

At the end of the duplication step (step 165), or directly after step 160 if no duplication is necessary, the streaming server 18 determines, during step 170, whether encoding is necessary. In other words, the streaming server 18 determines whether the video attributes of the second format are different from those of the first format.

When encoding is necessary, the control means 46 sends control signals to the encoding means 52, and the encoding means 52 then encodes the captured or duplicated, possibly decoded, image during step 175.

The control means 46 is also adapted to control the encryption of each captured or duplicated, possibly decompressed and/or encoded, image when the second format corresponds to encrypted data.

At the end of the encoding step (step 175), or directly after step 170 if no encoding is necessary, the streaming server 18 controls the transmission of the captured image and the Nd duplicated, possibly decoded and/or encoded, images in step 190.

The duration of a transmitted video is substantially equal to the capture period, also called first period ΔT1, or from 50 ms to 500 ms, preferably between 100 and 200 ms, preferably equal to 150 ms. The value of the first period ΔT1 is predetermined and set by the server 18. The streaming server 18 controls the transmitter-receiver 38 for the transmission of the video file to the remote client equipment 14.0. The captured, possibly decoded and/or duplicated and/or encoded, images are then transferred from the second buffer memory 36 towards the transmission-reception buffer memory 58, with a view to their autonomous transmission by the transmission means 56 of the transmitter-receiver.

In the embodiment of FIG. 5, a cycle comprising steps 120 to 170 has been carried out successively N times, with a decoding step 150, and a duplication step 165 and an encoding step 175 before the transmission of the images in video file form in each cycle. FIG. 5 also shows the storage in the first buffer memory 32 of captured images 0 to N, as well as storage in the second buffer memory 36 of the converted images. The numbers Nd0, . . . , NdN of duplicated images vary from one captured image to the next.

After transmission of the video file, the streaming server 18 lastly verifies, during step 200, that the user wishes to continue the remote copy mode, and returns to the capture step 120 if necessary. In the case where the user has stopped reading the image or video file using the control device 20, or has unchecked the “Activate copy mode” box and/or the “Activate server” box on the streaming server 18, then the streaming server 18 interrupts the remote copying method.

In the case of a new capture, the method also includes a step 210 for correcting the capture date of the next captured image as a function of the transmission duration of the preceding captured image. To that end, one determines the capture moment of the jth captured image, denoted TCj, as well as the transmission moment to the client equipment 14 of the video file containing the jth captured image, denoted TEj, as shown in FIG. 5, so as to calculate a temporal correction denoted A Corrj according to the following equation:

Corrj=ΔT1−(TEj−TCj) (6)

where ΔT1 represents the first period.

If the value of Corr_j is positive, then the streaming server 18 performs a time out equal to Corr_j before commanding the next image capture.

If on the contrary, the value of Corr_j is negative, then the streaming server 18 immediately commands the next image capture. The time correction is taken into account during the subsequent time corrections using the equation below until a time correction that is again positive has been obtained:

Corrj+1=2×ΔT1−(TEj+1+TCj+1)+Corrj (7)

$$Corrj + N = ( N + 1 ) \times Δ T 1 - ( TEN + 1 - TCN + 1 ) + {\sum }_{k = 0}^{N - 1} Corrj + k \qquad ( 8 )$$

The correction step 210 is implemented from the capture of the third image so as to avoid a loss of images to be displayed on the remote client equipment 14, in the case where the transmission by the transmitter-receiver 38 of the respective video files for the first two captured images is delayed. In other words, it is necessary for the remote client equipment 14 to have been adapted to store a sufficient number of images in a buffer memory, before implementing the correction step 210.

The mobile phone 12 and the local transmission network 10 according to the invention thus make it possible to copy an image displayed on the screen 24 of the mobile phone, remotely on the display screen 40 of the remote client equipment. The shift between the image displayed on the screen of the phone 12 and that copied on the screen of the remote equipment 14 depends on the duration of the file transmitted by the mobile phone 12. This duration is parameterizable depending on the user's needs and the capacities of the mobile phone 12 and the client device 22. This duration is, for example, between 50 ms and 500 ms, preferably between 100 and 200 ms, preferably equal to 150 ms.

The file transmitted by the mobile phone 12 and including the captured image is a video file or an image file, commonly displayed by the remote equipment 14, which allows compatibility with the remote equipment 14 when reading said file.

The step for correcting the capture date makes it possible to improve the regularity of the image captures, by correcting the following image capture moments, in the event a preceding image capture has been done with a delay.

One can thus see that the invention makes it possible to propose a mobile phone comprising a streaming server and offering an additional functionality, i.e. copying an image displayed on the screen of the mobile phone, remotely on the display screen of the remote client equipment.

1-11. (canceled)

12. A mobile phone comprising:
a display screen;
a display generator for generating an image to be displayed on the screen;
a capturer for capturing the image to be displayed on the screen, the capturer being adapted to capture the image passing between the display generator and the screen;
a streaming server for streaming data to remote client equipment according to a predetermined network protocol, the streaming server being adapted to be connected to the remote client equipment via a data link and to receive, from the remote client equipment, a data streaming request,
wherein the streaming server includes an activator for activating the capturer, the streaming server being adapted to send the captured image to the remote client equipment.

13. The mobile phone as recited in claim 12 wherein the activator is adapted to activate the capturer periodically according to a first period.

14. The mobile phone as recited in claim 12 wherein each captured image is according to a first format, the remote client equipment being compatible with a second format distinct from the first format, and wherein the mobile phone further includes a buffer memory connected to the capturer and adapted to store the captured image, a converter for converting each captured image from the first format to the second format, the converter being connected to an output of the buffer memory, the streaming server being adapted to transmit the converted image to the remote client equipment.

15. The mobile phone as recited in claim 14 wherein the streaming server includes a controller for controlling the converter, the controller being adapted to command the conversion of each captured image from the first format to the second format.

16. A local data communication network comprising:
a mobile phone as recited in claim 12; and
the remote client equipment connected to the mobile phone via the data link, the mobile phone and the remote client equipment being adapted to communicate using the predetermined network protocol.

17. The local network as recited in claim 16 wherein the activator is adapted to activate the capturer periodically according to a first period and wherein the remote client equipment includes a display for displaying, periodically according to a second period, each image received from the streaming server, and the first period is greater than or equal to the second period.

18. The local network as recited in claim 17 wherein the mobile phone further includes a buffer memory connected between the capturer and the streaming server, and a duplicator for duplicating the captured image in the buffer memory, the streaming server being adapted to communicate to the remote client equipment the images captured and duplicated, the number of duplicated images from each captured image depending on a ratio between the first period and the second period.

19. A method implemented by a mobile phone comprising a display screen, a display generator for generating an image to be displayed on the screen, a capturer for capturing the image to be displayed on the screen, and a streaming server connected to the capturer, the streaming server being adapted to be connected to the remote client equipment via a data link and to receive, from the remote client equipment, a data streaming request,
the method comprising:
selecting, by a user, a remote copy mode for remote copying of an image displayed on the screen of the mobile phone;
transmitting, by the streaming server, an activation signal for the capturer;
capturing, by the capturer, the image passing between the display generator and the screen, upon receipt of the activation signal, and
transmitting the captured image to the remote client equipment, by the streaming server according to a predetermined network protocol.

20. The method as recited in claim 19 wherein a video file including a plurality of images is transmitted during the transmitting of the captured image step.

21. The method as recited in claim 20 further comprising a step for correcting a capture time of the next captured image as a function of the transmission time of the preceding captured image.

22. A computer program product comprising instructions that, when implemented by a computer incorporated into a mobile phone, implements the method as recited in claim 19.
